(19) United States
(12) Patent Application Publication
(10) Pub. No.: US 2008/0182929 A1
(43) Pub. Date: Jul. 31, 2008

(54) Aqueous Coating Compositions Exhibiting Increased Open Time With Reduced Levels Of Volatile Organic Compounds

(75) Inventors: Arron Strepka, LaGrange Park, IL (US); Makarand V. Joshi, Grayslake, IL (US); William D. Arendt, Libertyville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: VELSICOL CHEMICAL CORPORATION, Rosemont, IL (US)

(21) Appl. No.: 12/061,836

(22) Filed: Apr. 3, 2008

Related U.S. Application Data
(63) Continuation-in-part of application No. 11/554,301, filed on Oct. 30, 2006.

(51) Int. Cl. C08K 5/09

(52) U.S. Cl. 524/291

(57) ABSTRACT

In addition to acting as effective plasticizers, dibenzoates of diethylene and dipropylene glycols in combination with at least one of the corresponding monoesters within a specified concentration range are unique in their ability to extend the open time exhibited by aqueous polymer compositions, and are thereby capable of replacing at least a portion of more volatile organic compounds (VOC.'s) such as diols, glycols and esters of mono-and dihydric alcohols and benzoates of monohydric alcohols that are typically used as coalescents for these polymer compositions.

This application is a continuation-in-part of application Ser. No. 11/554,301 filed Oct. 30, 2006, which is incorporated herein by reference.

### FIELD OF THE INVENTION

This invention relates to aqueous coating compositions. More particularly, this invention relates to increasing the open time of these coating compositions at relatively low levels of volatile organic compounds (VOCs) by replacing at least a portion of the VOCs with less volatile plasticizer/coalescent without adversely affecting other desirable properties of the composition. This is achieved using combinations of mono- and dibenzoates of glycols as both plasticizers and partial replacements for the more volatile organic compounds conventionally used as coalescents in these compositions. The compositions include but are not limited to coatings (including paints), self-supporting films, adhesives, sealants, inks, overprint varnishes and caulks.

### BACKGROUND

Aqueous polymer compositions employed, for example, as coatings, inks, adhesives, caulks and sealants typically require the presence of volatile organic compounds (VOC's) such as alcohols, glycols, esters and glycol ethers to achieve desirable properties. These properties include but are not limited to open time, the ability of the particles of film-forming polymer to coalesce at temperatures below the glass transition temperature of the polymers, resistance to gelation of the composition during repeated cycles of freezing and thawing and the adhesion, leveling, tool-ability, wet-edge, gloss development, and resistance to scrubbing and organic solvents exhibited by films and coatings applied using the compositions.

Recently several national and regional governments have issued restrictions concerning the amounts of volatile organic compounds (VOC's) that can be present in compositions intended for use as coatings, inks, sealants, adhesives and related applications. These restrictions have initiated efforts by manufactures and formulators of these compositions to seek ways to eliminate or at least reduce the concentration of VOC's in both aqueous and non-aqueous polymer compositions without adversely affecting the beneficial properties imparted by these compounds.

The use of benzoic acid esters as plasticizers for a variety of organic polymer compositions is well known. Patents disclosing the use of dibenzoates of dihydric alcohols alone or in combination with the corresponding monobenzoates include U.S. Pat. Nos. 6,583,207 and 5,676,742. Additional liquid blends of mono- and diesters of glycols and dihydric alcohols are disclosed in U.S. Pat. No. 7,056,966. Neither the efficacy of the benzoate blends as coalescents in coating compositions nor the ability of the mono-/dibenzoate blends to replace a portion of the VOCs are described. Conventional prior art coalescents are typically relatively volatile liquid organic compounds including but not limited to dihydric alcohols, glycols, oligomeric glycols, esters of said alcohols and glycols, and ethers. Preferred prior art coalescents include esters of aliphatic diols such as Texanol® and Texanol® diisobutyrate.

### SUMMARY

Provided herewith are low VOC aqueous coating compositions that include plasticizer/coalescents. The plasticizer/coalescents include combinations of benzoate esters that can be utilized as at least a partial replacement for VOCs in the coating composition. The replacement of VOCs with plasticizer/coalescent is effective for providing a composition with reduced VOCs and is effective for providing a coating binder with properties that are at least equivalent to or better than coating binders formed from composition made without replacement of VOCs with the plasticizer/coalescent. The aqueous coating compositions can be used in paints, caulks, inks, self-supporting films, adhesives, overprint varnishes and sealants.

The aqueous coating compositions described herein exhibit extended open time and reduced concentrations of VOCs. The aqueous compositions include
A. at least one film-forming organic polymer;
B. a plasticizer/coalescent for said polymer that includes
   i) at least one diester of the formula PhC(O)(OR¹)qO(O)CPh;
   ii) from 6 to 99 weight percent, based on the total weight of said plasticizer/coalescent, of at least one monoester having a formula PhC(O)(OR²)ᵣOH, wherein R¹ and R² are individually at least one member selected from the group consisting of alkylene radicals containing 2 or 3 carbon atoms, Ph is phenyl or alkylphenyl, and q and r are individually integers from 1 to 6, inclusive;
   iii) from 0 to 10 weight percent, based on the total weight of said plasticizer/coalescent, of benzoic acid or a corresponding alkylbenzoic acid;
C. at least one water-miscible volatile organic compound (V.O.C.) selected from the group consisting of dihydric alcohols, glycols, oligomeric glycols, esters of said alcohols and glycols, and ethers, wherein the composition has less than about 250 grams per liter of VOC; and
D. water.

The concentration of the plasticizer/coalescent is sufficient to reduce the concentration of VOCs that would otherwise be required to achieve a given level of open time in the absence of said plasticizer/coalescent.

In another aspect, a method is provided for preparing a low VOC aqueous polymer composition. The method includes blending
at least one film-forming organic polymer;
a plasticizer/coalescent for said polymer that includes
   i) at least one diester of the formula PhC(O)(OR¹)qO(O)CPh;
   ii) from 6 to 99 weight percent, based on the total weight of said plasticizer/coalescent, of at least one monoester having a formula PhC(O)(OR²)ᵣOH, wherein R¹ and R² are individually at least one member selected from the group consisting of alkylene radicals containing 2 or 3 carbon atoms, Ph is phenyl or alkylphenyl, and q and r are individually integers from 1 to 6, inclusive;
   ii) from 0 to 10 weight percent, based on the total weight of said
   plasticizer/coalescent, of benzoic acid or a corresponding alkylbenzoic acid;
at least one water-miscible volatile organic compound (V.O.C.) selected from the group consisting of dihydric alcohols, glycols, oligomeric glycols, esters of said alcohols and glycols, and ethers, wherein the composition has less than about 250 grams per liter of VOC; and water.
   The concentration of the plasticizer/coalescent is sufficient to reduce the concentration of VOCs that would otherwise be required to achieve a given level of open time in the absence of said plasticizer/coalescent.

In another aspect, coating binders are provided which are formed from the aqueous coatings described herein. The aqueous coatings are effective for providing coating binders that have the same improved properties as coating binders formed from aqueous coatings where at least a portion of the VOCs has not been replaced with plasticizer/coalescent. Properties which are the same or improved include increased open time, resistance to scrubbing, resistance to solvents and salt fog, wet-ability, wet-edge, leveling, gloss development, adhesion, tool-ability, and resistance to gelling of the composition during freeze-thaw cycles.

### DETAILED DESCRIPTION

The present invention is based on the discovery that that in addition to being effective coalescents and plasticizers, combinations of 1) one or more dibenzoates of monomeric or oligomeric ethylene, ethylene oxide, propylene and/or propylene oxide glycols, 2) from 6 to 99 weight percent, based on the total weight of mono- and dibenzoates, of at least one of the corresponding monobenzoates and 3) no more than 10 weight percent of unreacted benzoic acid extend the open time of aqueous polymer compositions, thereby permitting a reduction in the level of volatile organic compounds that would otherwise be required to achieve this duration of open time in the absence of these combinations. Using a range 6 to 99 weight percent, preferably 6 to 30 weight percent of monobenzoate, the observed levels of desirable coating properties such as resistance to scrubbing and solvents are at least equivalent to coatings prepared using compositions containing higher concentrations of the more volatile coalescents and open time extenders of the prior art, including alkyl benzoates. In an important aspect, plasticizer/coalescent replaces VOCs in an amount to provide an aqueous polymer composition with from 0.1 to 250 grams/liter VOC. In one aspect, the aqueous polymer compositions include less than about 250 g per/liter VOC, in another aspect less than about 200 g per liter/VOC, in another aspect less than about 175 g per liter/VOC, in another aspect less than about 150 g per liter/VOC, in another aspect less than about 125 g per liter/VOC, in another aspect less than about 100 g per liter/VOC, in another aspect less than about 75 g per liter/VOC, in another aspect less than about 50 g per liter/VOC, in another aspect less than about 25 g per liter/VOC, and in another aspect less than about 10 g per liter/VOC.

The aqueous polymer compositions can be applied to substrates to provide a coating binder having the same or improved properties including resistance to scrubbing, resistance to solvents and salt fog, wet-ability, gloss development, adhesion, and tool-ability, as compared to coating binders formed from aqueous coating compositions where VOCs have not been replaced with the plasticizer/coalescent. As used herein “coating binder refers to the polymeric part of the film after solvent has evaporated.

### Film Forming Organic Polymers

Organic polymers suitable for use as the film-forming ingredient in the aqueous compositions of the present invention include but are not limited to homopolymers and copolymers of acrylic and methacrylic acids and esters thereof, copolymers of acrylic and methacrylic acids and esters thereof with styrene, vinyl monomers, and ethylene; vinyl acetate-ethylene copolymers, polyvinyl alcohol, polyurethanes, epoxide polymers, epoxy-modified acrylic polymers, and mixtures of two or more of the aforementioned polymers. In an important aspect, the film-forming organic polymer is selected from the group consisting of acrylic, vinyl/acrylic copolymers, styrenated acrylic and vinyl acetate/ethylene copolymers.

### Plasticizer/Coalescent

The present combinations of benzoic acid esters include at least one diester of the generic formula PhC(O)(OR¹)qO(O)CPh and at least one monobenzoate of the generic formula PhC(O)(OR²)ᵣOH, wherein R¹ and R² are individually at least one member selected from the group consisting of alkylene radicals containing 2 and 3 carbon atoms, Ph is phenyl or alkyl-substituted phenyl, and q and r are individually integers from 1 to 6, inclusive. The monobenzoate(s) constitute from 6 to 99 weight percent, preferably from 6 to 30 weight percent of the ester combination, and the concentration of unreacted benzoic acid is less than ten weight percent. In one aspect, R¹ and R² are individually at least one of ethylene and isopropylene and said alkylphenyl is tolyl.

The concentration of the present benzoate mixtures (plasticizer/coalescent) is typically from about 1 to about 200 weight percent, based on the weight of film-forming polymers in the composition. In another aspect, the concentration of plasticizer/coalescent is about 1 to about 10 weight percent, in another aspect about 10 to about 20 weight percent, in another aspect about 20 to about 30 weight percent, in another aspect about 30 to about 50 weight percent, in another aspect about 50 to about 100 weight percent, and in another aspect about 100 to about 200 weight percent, all based on the weight of film-forming polymers in the composition. These mixtures replace at least a portion of the more volatile liquid organic compounds conventionally used to achieve desired levels of open time, coalescence and film properties.

In addition to extending open time, reducing the level of VOC's and functioning as coalescing agents, preferred benzoate ester combinations of this invention containing a total of 6 to 30 weight percent of monobenzoates and less than 10 weight percent of benzoic acid improve other properties of the polymer composition and/or of coatings applied using the compositions. These properties include but are not limited to resistance to gelation of the polymer compositions during freeze-thaw cycles, and the resistance of the applied coatings to scrubbing, solvents and salt fog. The definitions of the forgoing properties and test procedures for determining them are known to those skilled in the art of formulating coating compositions.

The end use applications of the aqueous polymer compositions of the present invention include but are not limited to coating materials such as paints and industrial coatings, adhesives, sealants, over-print varnishes, caulks, inks, and self-supporting films.

The following examples describe preferred coating compositions containing the benzoate combinations of this invention. The examples should not be interpreted as limiting the scope of benzoate combinations and film-forming compositions encompassed by the accompanying claimed. Unless otherwise indicated all parts and percentages in the examples are by weight and properties were measured at 25° C.

### EXAMPLE 1

Two benzoic ester combinations of this invention, identified as 1 and 2, and one for comparative purposes, identified as 1C, were prepared by reacting benzoic acid with diethylene glycol and/or dipropylene glycol in the molar ratios specified in table 1 using 0.03 weight percent of zirconium carbonate as the esterification catalyst. The compositions of these combinations in weight percent are listed in Table 1.

TABLE 1

| | | | % MONO- |
|---|---|---|---|
| COALESCENT | % DEGDB | % DPGDB | BENZOATE(S) |
| 1 | 65 | 23 | 12^{a} |
| 2 | 60 | 0 | 40^{b} |
| 1C | 47 | 47 | 6 |

^{a}a mixture of diethylene glycol monobenzoate and dipropylene glycol monobenzoate
^{b}diethylene glycol monobenzoate
Benzoate composition 1C was only evaluated in combination with Texanol ® as a control

For purposes of comparison the following coalescents were also evaluated: Texanol®; Texanol® isobutyrate; and a 1:2 weight ratio blend of Texanol® and the benzoate combination identified as 1C in Table 1.

Four paint compositions, referred to hereinafter as A, B, C and D, were prepared by mixing the ingredients in upper portion of Table 2 on a paint mill. The resultant material, referred to in the table as a “grind”, was then combined with the ingredients in the lower portion of the table (below “ADD TO GRIND”) to form the final paint. The concentrations of all ingredients listed in Table 2 are in parts by weight.

TABLE 2

| A | | B | | C | | D | |
|---|---|---|---|---|---|---|---|
| GRIND | | GRIND | | GRIND | | GRIND | |
| Water | 293.2 | Propylene Glycol | 21.5 | Water | 117.2 | Water | 192.0 |
| ER 15000 | 2.0 | Tamol 165 | 8.7 | Propylene | 3.0 | Tamol 850 | 9.0 |
| | | | | Glycol | | | |
| Nuosept 145 | 2.4 | Tego 805 | 2.1 | AMP 95 | 2.0 | KTPP | 1.5 |
| Tamol 731 | 9.2 | Kathon LX 1.5% | 1.7 | BYK 024 | 1.0 | AMP 95 | 1.7 |
| Triton N-57 | 2.1 | TiPure R-706 | 225.0 | Proxel GXL | 0.7 | Igepal CO 630 | 3.0 |
| AMP 95 | 1.0 | Water | 41.7 | Tamol 165 A | 10.8 | Hi-Mar DFC19 | 2.0 |
| Propylene Glycol | 17.2 | Aq. NH₃ (28%) | 2.0 | Triton CF 10 | 2.0 | Nuosept 95 | 1.5 |
| BYK 035 | 1.0 | | | Acrysol RM | 31.5 | Tipure R-706 | 200.0 |
| | | | | 2020NPR | | | |
| Tronox CR 800 | 250.0 | | | Ti-Pure | 221.6 | Mattex | 110.0 |
| | | | | R-706 | | | |
| ADD TO GRIIND | | ADD TO GRIND | | ADD TO GRIND | | No. 10 White | 150.0 |
| PREMIX NEXT THREE | | Water | 50.0 | NeoCryl | 561.5 | Celite 281F | 40.0 |
| | | | | XK 225 | | | |
| Propylene Glycol | 10.0 | Rhoplex SG 20 | 533.7 | Water | 36.0 | Attagel 40 | 10.0 |
| SCT 275 | 10.0 | Triton GR-7M | 2.1 | Triton N-57 | 4.9 | ADD TO GRIND | |
| Water | 10.0 | Tego 805 | 2.5 | BYK 333 | 2.0 | Airflex EF 811 | 216.1 |
| THEN ADD | | Aq. NH₃ (28%) | 1.4 | BYK 024 | 3.0 | Natrosol | 145 |
| | | | | | | Plus (3% Soln. | |
| UCAR 379 G | 428.4 | Acrysol RM 2020 | 19.3 | Acrylsol | 1.2 | Hi-Mar DFC 19 | 2.0 |
| | | | | RM 825 | | | |
| BYK 035 | 1.9 | Acrysol RM 8W | 2.0 | | | Hi-Mar DFC 19 | 2.0 |
| Triton GR 7M | 0.5 | Water | 90.0 | | | Water | 93.1 |

| | | | |
|---|---|---|---|
| Coalescent: See Table 4 | Coalescent: | Coalescent: See | Coalescent: |
| | See Table 4 | Table 4 | See Table 4 |

Benzoate combinations 1, 2 and the 1C/Texanol® mixture were blended as coalescents into separate portions of each of the four paint formulations in Table 2. The concentrations of the coalescents in parts by weight are listed in Table 4 together with the VOC level of the final composition in grams per liter.

All of the ingredients listed in Table 2 and in subsequent tables of formulations are identified in the following Table 3.

TABLE 3

| Material | Supplier | Description |
|---|---|---|
| Acrysol ® RM 2020 | Rohm and Haas | Rheology Modifier |
| NPR | | |
| Acrysol ® RM 825 | Rohm and Haas | Associative Thickener |
| Acrysol RM 8W | Rohm and Haas | Rheology Modifier |
| Airflex ® EF 811 | Air Products | Vinyl Acetate Ethylene |
| | | Emulsion |
| AMP ® 95 | Angus | Dispersant |
| Attagel ® 40 | Engelhard | Thickener |
| Avanse ® MV-100 | Rohm and Haas | Acrylic Emulsion |
| BYK 024 | BYK-Chemie, USA | Defoamer |
| BYK 035 | BYK-Chemie, USA | Deoamer |
| BYK 333 | BYK-Chemie, USA | Surface Additive |
| Celite ® 281F | Celite | Pigment Extender |
| Cellosize ® ER 15000 | Dow/Union Carbide | Thickener |
| Drew Plus ® L-493 | Ashland-Drew Industrial | Defoamer |
| DPnB | Dow | Filming Aid |
| Hi-Mar ® DFC 19 | Hi-Mar Specialty Chemicals LLC | Defoamer |
| Igepal ® CO 630 | Rhone-Poulenc Surfactants and | Wetting Agent |
| | Specialties | |
| Kathon ® LX | Rohm and Haas | Preservative |
| Mattex ® | Engelhard Corp | Pigment |
| Natrasol ® Plus 330 | Aqualon | Thickener |
| Plus | | |
| NeoCryl ® XK 225 | DSM NeoResins | Styrenated Acrylic Emulsion |
| No. 10 White | Georgia Marble | Pigment Extender |
| Nuosept ® 145 | Huls America | Preservative |
| Nuosept ® 95 | Huls America | Preservative |
| Proxel ® GXL | Zeneca Biocides | Antimicrobial |
| Rhoplex ® SG 20 | Rohm and Haas | Acrylic Emulsion |
| SCT 275 | Rohm and Haas | Thickener |
| Surfynol ® CT-111 | Air Products and Chemicals, Inc. | Wetting Aid |
| Tamol ® 165 | Rohm and Haas | Dispersant |
| Tamol ® 165A | Rohm and Haas | Dispersant |
| Tamol ® 731 | Rohm and Haas | Dispersant |
| Tamol ® 850 | Rohm and Haas | Dispersant |
| Tamol(G) 2001 | Rohm and Haas | Dispersant |
| Tego ® 805 | Goldschmidt Industrial Specialties | Defoamer |
| Texanol ® | Eastman | Filming Aid |
| Texanol ® | Eastman | Filming Aid |
| isobutyrate | | |
| TiPure ® R-706 | DuPont | Pigment |
| Triton ® CF 10 | Dow/Union Carbide | Wetting Agent |
| Triton ® GR 7M | Dow/Union Carbide | Wetting Agent |
| Triton ® N-57 | Dow/Union Carbide | Emulsifier |
| Tronox ® CR 800 | Kerr-McGee | Pigment |
| UCAR ® 379G | Dow Ucar Emulsions | Vinyl Acrylic Emulsion |

The formulations described in Table 2 were evaluated for scrub resistance following the procedure described in ASTM test procedure D 2486.

The concentrations of the coalescents in parts by weight, the VOC's of the formulation and the results of the evaluations are recorded in Table 4.

TABLE 4

| COMPOSITION | A | B | C | D |
|---|---|---|---|---|
| Coalescent 1 | 8.0 | 14.3 | 31.9 | 8.9 |
| Formulation VOC (g./liter) | 91 | 66 | 19 | 5 |
| Scrub Resistance (cycles) | 5402 | 466 | 382 | 261 |
| Texanol ® Diisobutyrate (Control) | 8.0 | NE | NE | NE |
| Formulation VOC (g./liter) | 115 | | | |
| Scrub Resistance (cycles) | 3424 | | | |
| Texanol ® (Control) | NE | 14.3 | NE | NE |
| Formulation VOC (g./liter) | | 106 | | |
| Scrub Resistance (cycles) | | 435 | | |
| Texanol ®/1C (1:2 wt. ratio) (Control) | NE | NE | 34.8 | NE |
| Formulation VOC (g./liter) | | | 48 | |
| Scrub Resistance (cycles) | | | 323 | |
| DPG Dibenzoate (Control) | NE | NE | NE | 8.9 |
| Formulation VOC (g./liter) | | | | 4 |
| Scrub Resistance (cycles) | | | | 234 |
| Coalescent 2 | 8.0 | 14.3 | 29.0 | 8.9 |
| Formulation VOC (g./liter) | 92 | 66 | 20 | 5 |
| Scrub Resistance (cycles) | 3231 | 470 | 401 | 233 |

NE = formulation not evaluated
DPG = dipropylene glycol

The higher scrub resistance exhibited by compositions A, B and C containing coalescent 1 of the present invention relative to the same compositions containing Texanol and Texanol isobutyrate is unexpected based on the lower VOC level of the benzoate.

The monobenzoate concentration of coalescents 2 is outside of the preferred range of 6 to 30 weight percent of the total benzoate combination. Coalescent 1 containing 12 weight percent of the monobenzoate is within this range. Coalescent 1 exhibited higher scrub resistance than coalescent 2 in two of the four formulations.

The resistance to cycles of freezing and thawing of coating composition A containing each of the four coalescents was evaluated using ASTM test procedure D 2243. The sample containing Coalescent 1 withstood 3 cycles, demonstrating a superior resistance to the sample containing Texanol, which failed after only 1 cycle.

The samples of compositions C and D all failed after one freeze/thaw cycle, demonstrating equivalent performance for the present benzoate composition relative to Texanol.

The samples of composition C were evaluated for blocking resistance using ASTM test procedure D4946. The sample containing Coalescent 1 demonstrated equivalent performance relative to the control compositions.

### EXAMPLE 2

This example demonstrates the higher resistance to salt fog and methyl ethyl ketone exhibited by high gloss paint, referred to hereinafter as composition D. The commercial products are identified in the preceding Table 3.

The paint was prepared by blending the following ingredients to homogeneity on a paint mill: 50 parts of water; 7.9 parts of Tamol® 2001; 2.0 parts of Surfynol® CT-111; 1.0 part of Drew Plus® L-493; 2.0 parts of a 28% aqueous solution of ammonia; and 220.0 parts of Ti-Pure R-706. The resultant mixture was blended with 530 parts of Avanse MV-100; 132 parts of water; 7.0 parts of a 28% aqueous solution of ammonia; 18.5 parts of propylene glycol and one of the following coalescents: coalescent 1—19.4 parts from Example 1; coalescent 2—15.2 parts of the 1:1 weight ratio mixture of Texanol® and DPnB.

Each of the paint compositions was applied to the appropriate substrate and allowed to dry for the specified time, following which the resultant coatings were evaluated for resistance to rusting following a 400-hour salt fog exposure using ASTM test B117 and chemical resistance by being rubbed with methyl ethyl ketone using the procedure described in ASTM test D4752.

The following results were observed:

| | Rust Following Salt Fog Exposure | Chemical Resistance |
|---|---|---|
| Coalescent | 10 = no rust; 1 = completely rusted | Double Rubs for Coating |
| 1 | 8 | 58 |
| 2 | 4 | 57 |

The results of this evaluation demonstrate that benzoate combination 1 is an effective coalescent, combination 1 with a monobenzoate content of 12 weight percent, which is within the preferred range of from 6 to 30, exhibited the highest rating in both the salt fog and chemical resistance tests.

### EXAMPLE 3

The benzoic ester composition of this invention identified in the preceding examples as coalescent 1 was evaluated for open time and water resistance in two different paint compositions together with Texanol at three different concentration levels.

One of the two paint compositions, containing Rhoplex® SG20 as the film-forming polymer, was prepared by mixing the ingredients in upper portion of Table 5 on a paint mill. The resultant material, referred to in the table as a “grind”, was then combined with the ingredients in the lower portion of the table (below “Add to Grind”) to form the final paint. The concentrations of all ingredients listed in Table 5 are in parts by weight.

TABLE 5

| | COMPOSITION | | | |
|---|---|---|---|---|
| | E¹ | F¹ | G¹ | H |
| Coalescent/VOC | Texanol: | Texanol: | Texanol: | Coalescent |
| of Composition | 50 g/L | 106 g/L | 250 g/L | 1: 50 g/L |
| Grind | | | | |
| Tamol 165 | 8.70 | 8.70 | 8.70 | 8.70 |
| Tego 805 | 2.10 | 2.10 | 2.10 | 2.10 |
| TiPure R706 | 225.00 | 225.00 | 225.00 | 225.00 |
| Water | 54.90 | 54.90 | 54.90 | 54.90 |
| Ammonia 20% | 2.00 | 2.00 | 2.00 | 2.00 |
| Add to Grind | | | | |
| Water | 36.80 | 36.80 | 36.80 | 36.80 |
| Rhoplex ® SG-20 | 533.70 | 533.70 | 533.70 | 533.70 |
| Texanol | 14.30 | 14.30 | 14.30 | 0.00 |
| Coalescent 1 | 0.00 | 0.00 | 0.00 | 14.30 |
| Propylene Glycol | 0.99 | 21.89 | 87.54 | 14.92 |
| Triton GR 7M | 2.10 | 2.10 | 2.10 | 2.10 |
| Tego 805 | 2.50 | 2.50 | 2.50 | 2.50 |
| Ammonia 20% | 1.40 | 1.40 | 1.40 | 1.40 |
| RM 2020 | 19.30 | 19.30 | 19.30 | 19.30 |
| RM 8W | 2.00 | 2.00 | 2.00 | 2.00 |
| Water | 90.00 | 90.00 | 90.00 | 90.00 |

¹control compositions evaluated for comparative purposes

A second paint composition containing Aquamac® 440 as the film-forming polymer was prepared in the same manner described in the preceding paragraph and Table 2. The types and ingredients of this paint composition are listed in Table 6. As in Table 5, the concentrations of Coalescent 1 and Texanol are listed.

TABLE 6

| | COMPOSITION | | | |
|---|---|---|---|---|
| | I¹ | J¹ | K¹ | |
| | Texanol/ | Texanol/ | Texanol/ | L |
| Coalescent/VOC of | 68 | 188 | 250 | Coalescent 1/ |
| Composition | g/L | g/L | g/L | 50 g/L |
| Grind | | | | |
| Water | 50.0 | 50.0 | 50.0 | 50.0 |
| Tamol 681 | 7.0 | 7.0 | 7.0 | 7.0 |
| Surfynol 104a | 3.0 | 3.0 | 3.0 | 3.0 |
| AMP-95 | 2.0 | 2.0 | 2.0 | 2.0 |
| Nuosept 95 | 2.0 | 2.0 | 2.0 | 2.0 |
| Dehydran 1620 | 1.5 | 1.5 | 1.5 | 1.5 |
| Tiona RCL 595 | 195.0 | 195.0 | 195.0 | 195.0 |
| RM 2020 | 5.0 | 5.0 | 5.0 | 5.0 |
| Add to Grind | | | | |
| Aquamac 440 | 507.4 | 507.4 | 507.4 | 507.4 |
| AMP-95 | 2.0 | 2.0 | 2.0 | 2.0 |
| Texanol | 25.0 | 25.0 | 25.0 | 0.0 |
| Composition 1 | 0.0 | 0.0 | 0.0 | 25.0 |
| Propylene Glycol | 0.0 | 51.8 | 78.5 | 15.8 |
| Paraplex WP-1 | 15.0 | 15.0 | 15.0 | 15.0 |
| Water | 104.1 | 104.1 | 104.1 | 104.1 |
| Dehydran 1620 | 0.5 | 0.5 | 0.5 | 0.5 |
| RM 2020 | 15.0 | 15.0 | 15.0 | 15.0 |

¹control compositions evaluated for comparative purposes

All of the ingredients listed in Tables 5 and 6 are identified in the following Table 7

TABLE 7

| Material | Supplier | Description |
|---|---|---|
| AMP ® 95 | Angus | Dispersant |
| Aquamac 440 | Hexion Specialty Chemicals | Styrenated Acrylic |
| | | Emulsion |
| Dehydran ® 1620 | Cognis | Defoamer |
| Nuosept ® 95 | Huls America | Preservative |
| Paraplex ® WP-1 | Rohm and Haas | Plasticizer |
| Rhoplex ® SG 20 | Rohm and Haas | Acrylic Emulsion |
| RM 2020 | Rohm and Haas | Thickeners |
| RM 8W | Rohm and Haas | Thickeners |
| Surfynol ® 104A | Wetting aid | Air Products and |
| | | Chemicals Inc. |
| Tamol ® 165 | Rohm and Haas | Dispersant |
| Tamol ® 681 | Rohm and Haas | Dispersant |
| Tego ® 805 | Goldschmidt Industrial | Defoamer |
| | Specialties | |
| Texanol ® | Eastman | Filming Aid |
| Tiona ® RCL 595 | Millennium Chemical | Pigment |
| TiPure ® R-706 | DuPont | Pigment |
| Triton ® GR 7M | Dow/Union Carbide | Wetting Agent |

Compositions H and L contained coalescent 1. Compositions E, F and G and I, J and K contained Texanol, and were evaluated for comparative purposes

The open time of all of the compositions were determined by applying them using a 3 inch-wide brush with vertical strokes onto a paper substrate available as BH chart available from Leneta. Immediately following application of the coatings the figure “X” was inscribed on each paint sample using the handle of the brush and a timer was started. At predetermined time intervals the brush is rewetted and a horizontal stripe is painted across the “X”. The longest interval following which the paint immediately adjacent to the “X” can be blended in with the newly applied paint is referred to as the “open time”. The data from these evaluations appears in the following Table 8.

All of the compositions were also evaluated for water resistance using a ball peen hammer with a 2″×2″ gauze pad affixed. The gauze is moistened with water. Dragging the hammer back and forth one time is recorded as a double rub. The number of double rubs to reveal the substrate is recorded. The results of the open time and water resistance evaluations are recorded in the following Table 8.

TABLE 8

| | OPEN TIME | WATER RESISTANCE |
|---|---|---|
| COMPOSITION/VOC | (SECONDS) | (DOUBLE RUBS) |
| E (CONTROL)/50 g/L | 240 | 255 |
| F (CONTROL)/106 g/L | 315 | 387 |
| G (CONTROL)/250 g/L | 495 | 400 |
| H (INVENTION)/50 g/L | 315 | 400 |
| I (CONTROL)/68 g/L | 60 | 400 |
| J (CONTROL)/106 g/L | 255 | 400 |
| K (CONTROL)/250 g/L | 360 | 400 |
| L (INVENTION)/50 g/L | 180 | 400 |

The data in Table 8 demonstrate the following: For compositions E through H, formulation H containing the benzoate composition with a VOC level of 50 g/l exhibited an open time equivalent to paint formulation F containing Texanol and exhibiting a VOC level of 106. The water resistance of paint formulation H was nearly twice that of formulation E exhibiting the same VOC level.

For formulations I through L, the open time of 180 seconds exhibited by formulation L of this invention with a VOC level of 50 g/l was 3 times that of control formulation I, which had a VOC level of 60 g/l. To achieve an open time of 255 seconds required a VOC level of 188 g/l (formulation J).

That which is claimed is:

1. An aqueous coating composition comprising:
A. at least one film-forming organic polymer;
B. a plasticizer/coalescent for said polymer that includes
i) at least one diester of the formula PhC(O)(OR¹)qO(O)CPh;
ii) from 6 to 99 weight percent, based on the total weight of said plasticizer/coalescent, of at least one monoester having a formula PhC(O)(OR²)ᵣOH, wherein R¹ and R² are individually at least one member selected from the group consisting of alkylene radicals containing 2 or 3 carbon atoms, Ph is phenyl or alkylphenyl, and q and r are individually integers from 1 to 6, inclusive;
iii) from 0 to 10 weight percent, based on the total weight of said plasticizer/coalescent, of benzoic acid or a corresponding alkylbenzoic acid;
C. at least one water-miscible volatile organic compound (VOC) selected from the group consisting of dihydric alcohols, glycols, oligomeric glycols, esters of said alcohols and glycols, and ethers, wherein the composition has less than about 250 grams per liter of VOC; and
D. water;
wherein the concentration of said plasticizer/coalescent is sufficient to reduce the concentration of VOCs that would otherwise be required to achieve a given level of open time in the absence of said plasticizer/coalescent, and wherein plasticizer/coalescent is effective for improving properties of films formed from said compositions

2. The composition of claim 1 wherein films formed from said composition have improved properties selected from the group consisting of increased open time, resistance to scrubbing, resistance to solvents and salt fog, wet-ability, wet-edge, leveling, gloss development, adhesion, tool-ability, and resistance to gelling of said composition during freeze-thaw cycles as compared to films formed from compositions where VOCs have not been replaced with the plasticizer/coalescent.

3. The composition of claim 1 wherein said plasticizer/coalescent is from 1 to 200 percent of the total weight of said film-forming organic polymer

4. The composition of claim 1 wherein said film-forming organic polymer is at least one member selected from the group consisting of homopolymers and copolymers of acrylic and methacrylic acids and esters thereof, copolymers of acrylic and methacrylic acids and esters thereof with styrene, vinyl monomers, and ethylene; vinyl acetate-ethylene copolymers, polyvinyl alcohol, polyurethanes, epoxide polymers, epoxy-modified acrylic polymers, and mixtures thereof.

5. The composition of claim 4 wherein the film-forming organic polymer is selected from the group consisting of acrylic, vinyl/acrylic copolymers, styrenated acrylic and vinyl acetate/ethylene copolymers.

6. The composition of claim 1 wherein R¹ and R² are individually at least one of ethylene and isopropylene and said alkylphenyl is tolyl.

7. The composition of claim 1 wherein the monoester is from 6 to 30 weight percent of said plasticizer/coalescent.

8. The composition of claim 1 wherein said composition is a coating, a paint, an ink, an overprint varnish, a film, an adhesive, a caulk or a sealant.

9. A method for preparing a low VOC aqueous polymer composition, said method comprising blending
at least one film-forming organic polymer;
a plasticizer/coalescent for said polymer that includes
i) at least one diester of the formula PhC(O)(OR¹)qO(O)CPh;
ii) from 6 to 99 weight percent, based on the total weight of said plasticizer/coalescent, of at least one monoester having a formula PhC(O)(OR²)ᵣOH, wherein R¹ and R² are individually at least one member selected from the group consisting of alkylene radicals containing 2 or 3 carbon atoms, Ph is phenyl or alkylphenyl, and q and r are individually integers from 1 to 6, inclusive;
iii) from 0 to 10 weight percent, based on the total weight of said plasticizer/coalescent, of benzoic acid or a corresponding alkylbenzoic acid;
at least one water-miscible volatile organic compound (V.O.C.) selected from the group consisting of dihydric alcohols, glycols, oligomeric glycols, esters of said alcohols and glycols, and ethers, wherein the composition has less than about 250 grams per liter of VOC; and
water;
wherein the concentration of said plasticizer/coalescent is sufficient to reduce the concentration of VOCs that would otherwise be required to achieve a given level of open time in the absence of said plasticizer/coalescent, and wherein plasticizer/coalescent is effective for improving properties of films formed from said compositions

10. The method of claim 9 wherein films formed from said composition have improved properties selected from the group consisting of increased open time, resistance to scrubbing, resistance to solvents and salt fog, wet-ability, wet-edge, leveling, gloss development, adhesion, tool-ability, and resistance to gelling of said composition during freeze-thaw cycles as compared to films formed from compositions where VOCs have not been replaced with the plasticizer/coalescent.

11. The method of claim 9 wherein said plasticizer/coalescent is from 1 to 200 percent of the total weight of said film-forming organic polymer

12. The method of claim 9 wherein said film-forming organic polymer is at least one member selected from the group consisting of homopolymers and copolymers of acrylic and methacrylic acids and esters thereof, copolymers of acrylic and methacrylic acids and esters thereof with styrene, vinyl monomers, and ethylene; vinyl acetate-ethylene copolymers, polyvinyl alcohol, polyurethanes, epoxide polymers, epoxy-modified acrylic polymers, and mixtures thereof.

13. The method of claim 12 wherein the film-forming organic polymer is selected from the group consisting of acrylic, vinyl/acrylic copolymers, styrenated acrylic and vinyl acetate/ethylene copolymers.

14. The method of claim 9 wherein R¹ and R² are individually at least one of ethylene and isopropylene and said alkylphenyl is tolyl.

15. The method claim 9 wherein the monoester is from 6 to 30 weight percent of said plasticizer/coalescent.

16. A coating binder formed from an aqueous coating composition, the aqueous coating composition comprising:
A. at least one film-forming organic polymer;
B. a plasticizer/coalescent for said polymer that includes
1) at least one diester of the formula PhC(O)(OR¹)qO(O)CPh;
2) from 6 to 99 weight percent, based on the total weight of said plasticizer/coalescent, of at least one monoester having a formula PhC(O)(OR²)ᵣOH, wherein R¹ and R² are individually at least one member selected from the group consisting of alkylene radicals containing 2 or 3 carbon atoms, Ph is phenyl or alkylphenyl, and q and r are individually integers from 1 to 6, inclusive;
3) from 0 to 10 weight percent, based on the total weight of said plasticizer/coalescent, of benzoic acid or a corresponding alkylbenzoic acid;
C. at least one water-miscible volatile organic compound (V.O.C.) selected from the group consisting of dihydric alcohols, glycols, oligomeric glycols, esters of said alcohols and glycols, and ethers, wherein the composition has less than about 250 grams per liter of VOC; and
D. water;
wherein the concentration of said plasticizer/coalescent is sufficient to reduce the concentration of VOCs that would otherwise be required to achieve a given level of open time in the absence of said plasticizer/coalescent, and wherein plasticizer/coalescent is effective for improving properties of films formed from said compositions
wherein the aqueous coating composition is effective for providing a coating binder having improved properties selected from the group consisting of resistance to scrubbing, resistance to solvents and salt fog, wet-ability, gloss development, adhesion, and tool-ability, as compared to coating binders formed from aqueous coating compositions where VOCs have not been replaced with the plasticizer/coalescent.

17. The coating binder of claim 16 wherein said plasticizer/coalescent is from 1 to 200 percent of the total weight of said film-forming organic polymer

18. The coating binder of claim 16 wherein said film-forming organic polymer is at least one member selected from the group consisting of homopolymers and copolymers of acrylic and methacrylic acids and esters thereof, copolymers of acrylic and methacrylic acids and esters thereof with styrene, vinyl monomers, and ethylene; vinyl acetate-ethylene copolymers, polyvinyl alcohol, polyurethanes, epoxide polymers, epoxy-modified acrylic polymers, and mixtures thereof.

19. The coating binder of claim 16 wherein R¹ and R² are individually at least one of ethylene and isopropylene and said alkylphenyl is tolyl.

20. The coating binder of claim 16 wherein the monoester is from 6 to 30 weight percent of said plasticizer/coalescent.
